(19) United States
(12) Patent Application Publication
(10) Pub. No.: US 2004/0234867 A1
(43) Pub. Date: Nov. 25, 2004

(54) Ferroelectric material, two-color holographic recording medium, and wavelength selection filter

(75) Inventors: Hideki Hatano, Tsurugashima-shi (JP); Youwen Liu, Tsukuba-shi (JP); Kenji Kitamura, Tsukuba-shi (JP); Shunji Takekawa, Tsukuba-shi (JP); Masaru Nakamura, Tsukuba-shi (JP); Yasunori Furukawa, Kitakoma (JP)

Correspondence Address: MORGAN LEWIS & BOCKIUS LLP, 1111 PENNSYLVANIA AVENUE NW, WASHINGTON, DC, 20004, US

(73) Assignees: Pioneer Corporation; National Institute for Materials Science; OXIDE Corporation

(21) Appl. No.: 10/798,974

(22) Filed: Mar. 12, 2004

(30) Foreign Application Priority Data
Mar. 14, 2003 (JP) 2003-69897
Feb. 17, 2004 (JP) 2004-40215

(51) Int. Cl. G03H 1/02

(52) U.S. Cl. 430/1; 430/2; 359/7

(57) ABSTRACT

A ferroelectric material in which the refractive index change can be induced by irradiation with light at two different wavelengths without performing a reduction treatment or doping impurities. The ferroelectric material of the invention in which the refractive index change is induced by irradiation with light at two different wavelengths is a lithium tantalate single crystal with the composition of Li₂O/(Li₂O+Ta₂O₅)=0.4966 to 0.4995. Preferably, the ferroelectric material is a lithium tantalate single crystal with the composition of Li₂O/(Li₂O+Ta₂O₅)=0.4974 to 0.4989. Preferably, the infrared absorption coefficient in the [OH] stretching mode falls within a range of 0 cm⁻¹ to 0.15 cm⁻¹ (0 cm⁻¹ and 0.15 cm⁻¹ are included in the range).

### BACKGROUND OF THE INVENTION

1. Field of the Invention

The present invention relates to a ferroelectric material in which variations in the refractive index are induced by irradiation with two beams of light. More particularly, the present invention relates to a ferroelectric material that comprises a lithium tantalate single crystal in which there is an excess of lithium relative to the lithium tantalate with the congruent composition, and there is a deficit of Li relative to the lithium tantalate with the stoichiometric composition; and to a two-color holographic recording medium and a wavelength selection filter in which this material is used.

2. Description of the Related Art

Lithium tantalate (LiTaO₃, referred to as “LT” hereinbelow), lithium niobate (LiNbO₃, referred to as “LN” hereinbelow), and other ferroelectric single crystals are known as materials that exhibit photorefractive effect. The photorefractive effect is a phenomenon caused by irradiation with light in an electrooptic substance that has deep trap levels due to impurities and defects. Specifically, charges at a trap level are ionized by light and become free carriers (electrons or holes), and the free carriers move through the electrooptic substance. The free carriers subsequently recombine, creating a space charge distribution that corresponds to the intensity distribution of light. This creates variations in the refractive index based on the electro-optic effect (i.e., Pockels effect).

Digital holographic recording/playback systems (so-called “holographic memory systems”) based on the use of the principle of holography are known as examples of the effective use of such a photorefractive effect.

A holographic memory system is an optical memory system in which three-dimensional multiplexed recording of information in the form of a volumetric hologram can be accomplished by using light. Specifically, a holographic memory system can record and/or play back data in units composed of two-dimensional flat pages. Also, a holographic memory system can provide multiplexed recording (i.e., to record data in three dimensions in a recording medium) by using a plurality of two-dimensional flat pages. A recording medium used in such holographic memory systems can be obtained by machining the aforementioned ferroelectric single crystal into the shape of a rectangular parallelepiped or other three-dimensional figure.

Monochromatic holographic (one-color) systems are one of the recording modes used in such holographic memory systems. One-color holographic systems are systems in which recording and/or playback is performed by the interference of coherent light having a single wavelength (e.g., Japanese Patent Kokai No. H11-35393). The one-color holographic systems are disadvantageous, however, in that reproducing light gradually erases the recorded information (hologram) (reproduction degradation occurs) when the hologram is read, for which reason two-color holographic systems (two-color) devoid of the drawbacks of one-color holographic systems are being investigated. Two-color holographic systems are systems in which, in addition to being recorded by recording light used during recording, information is recorded by irradiation with gating light whose wavelength is different from the wavelength of recording light.

Following is a description of the principle whereby information is recorded on a holographic recording medium in a two-color holographic system.

FIG. 1 is a schematic diagram illustrating the principle of a two-color holographic system.

The energy band structure 1100 of the holographic recording medium used in the two-color holographic system has three energy levels A, B, and C between the valence band (VB) and the conduction band (CB). Enerigy level A (photoabsorption site or bipolaron) is deeper than energy level B (intermediate excitation level, metastable level, or small polaron). Energy level C (trap level or storage center) is in a deeper position than energy level B.

Holographic recording medium is irradiated by a gating light (wavelength: λ₁) to generate carriers that contribute to the photorefractive effect. The electrons at energy level A in the area irradiated by the gating light are excited into the conduction band (CB) and are temporarily trapped at energy level B. Carriers that contribute to the photorefractive effect are thereby generated. In the present specification, the levels that play a role such as that of energy level A are referred to as “gate sources”, and the spatial concentration of such gate sources is referred to as “the concentration of gate sources”.

The holographic recording medium is irradiated by the recording light to record information on the holographic recording medium. The recording light may, for example, consists of reference light (wavelength: λ₂), and information carrying signal light (wavelength: λ₂). The relation between wavelength λ₁ and wavelength λ₂ satisfies the condition λ₁<λ₂. The carriers trapped at energy level B are excited by the irradiation with recording light into the conduction band (CB) in accordance with the spatial light pattern that corresponds to the interference fringes formed by the recording light, and are ultimately accumulated at energy level C in a manner that the carrier concentration distribution corresponds to the intensity distribution of interference fringes. A record is thus completed.

LN that has undergone a reduction treatment has been suggested as a material for holographic recording media in which the aforementioned two-color holographic system may be adopted. A recording medium for two-color holograms can be an non-doped LN single crystal that has undergone a reduction treatment and is free of impurities, or an Fe(Iron) doped LN single crystal that has undergone a reduction treatment and contains added Fe (iron) (see, for example, L. Hesselink, S. S. Orlov, A. Liu, A. Akella, D. Lande, and R. R. Neurgaonkar, “Photorefractive Materials for Nonvolatile Volume Holographic Data Storage,” Science, Vol. 282 (Nov. 6), p. 1089-1094 (1998)). Using such single crystals makes it possible to form intermediate excitation levels (metastable levels) that have lives on the order from milliseconds to several seconds during recording, and to make recordings by using low-power continuous excitation lasers.

An Fe-doped LT crystal with the congruent composition that has undergone a reduction treatment is another example of a recording medium for two-color holograms (see, for example, J. Imbrock, D. Kip, and E. Kraetzig, “Nonvolatile holographic storage in iron-doped lithium tantalate with continuous-wave laser light,” Optics Letters, Vol. 24, No. 18, p. 1302-1304 (1999)).

The recording media described in these two nonpatent reference documents require that a reduction treatment be performed, however. This is because a material in an as-grown or heat-treated state has low recording sensitivity, and hence cannot be used as a recording medium. Moreover, a reduction treatment can sometimes increase the dark conductivity of a material and reduce the dark storage time of a recording medium. In addition, controlling and optimizing the properties as recording medium (for example, the recording sensitivity) is difficult because the characteristics of the resulting material vary considerably with the reduction treatment conditions (temperature, atmosphere, time, and the like).

Furthermore, the recording medium described in the second nonpatent reference document is such that the lifetime of the intermediate excitation level is short (several milliseconds) and as a result, the concentration of electrons at the intermediate excitation level is low. Consequently, this recording medium fails to generate adequate recording sensitivity even when a reduction treatment is performed.

In addition, the recording media described in the two nonpatent reference documents contain a dopant, and hence have unneeded absorption bands induced by the dopant (Fe) at shorter wavelengths. For this reason, the transmissivity of gating light is reduced, making it impossible to use thick crystals and impeding achievement of high capacities.

### SUMMARY OF THE INVENTION

Consequently, it is an object of the present invention to provide a ferroelectric material in which the refractive index change is induced by irradiation with light at two different wavelengths without performing a reduction treatment or doping.

Another object of the present invention is to provide a two-color holographic recording medium in which the aforementioned ferroelectric material is used.

Yet another object of the present invention is to provide a filter in which the aforementioned ferroelectric material is used.

The present invention provides a ferroelectric material in which the refractive index change is induced by irradiation with light at two different wavelengths, wherein the ferroelectric material is a lithium tantalate single crystal with the composition Li₂O/(Li₂O+Ta₂O₅)=0.4966 to 0.4995.

The present invention also provides a two-color holographic recording medium obtained using a ferroelectric material in which variations in the refractive index are induced by irradiation with light at two different wavelengths, wherein the ferroelectric material is a lithium tantalate single crystal with the composition Li₂O/(Li₂O+Ta₂O₅)=0.4966 to 0.4995.

The present invention further provides a wavelength selection filter obtained using a ferroelectric material in which variations in the refractive index are induced by irradiation with light at two different wavelengths, wherein the ferroelectric material is a lithium tantalate single crystal with the composition Li₂O/(Li₂O+Ta₂O₅)=0.4966 to 0.4995, and wherein the ferroelectric material has at least one refractive index lattice.

### BRIEF DESCRIPTION OF THE DRAWINGS

FIG. 1 is a schematic diagram illustrating the principle of a two-color holographic system;

FIG. 2 is a general phase diagram of an Li₂O—Ta₂O₅ pseudo-binary system;

FIG. 3 is a schematic diagram of a system for measuring optical characteristics;

FIGS. 4A and 4B are diagrams depicting variations in the refractive index, and the dependence of sensitivity on the Curie temperature of a ferroelectric material comprising an NSLT single crystal in accordance with the present invention, respectively;

FIG. 5 is a diagram depicting the relation between the Curie temperature and composition of an LT single crystal;

FIG. 6 is a diagram depicting variations in the refractive index of a ferroelectric material comprising an NSLT single crystal in accordance with the present invention in the recording, playback, and erase steps;

FIGS. 7A and 7B are diagrams depicting the temperature dependence of the dark decay time constant of hologram, and the proton concentration dependence of storage lifetime at room temperature, respectively;

FIG. 8 is a schematic diagram of a recording/playback device for recording information on a two-color holographic recording medium according to the present invention, and/or playing back information from the two-color holographic recording medium;

FIGS. 9A and 9B are schematic diagrams illustrating the method and principle of fabricating a wavelength selection filter;

FIG. 10 is a schematic diagram of a wavelength selection filter for WDM; and

FIG. 11 is a schematic diagram depicting a filter system according to the present invention.

### DESCRIPTION OF THE PREFERRED EMBODIMENTS

Examples of the present invention are described below with reference to the accompanying drawings. In the present invention, a lithium tantalate single crystal is used as the ferroelectric material.

(Embodiment 1)

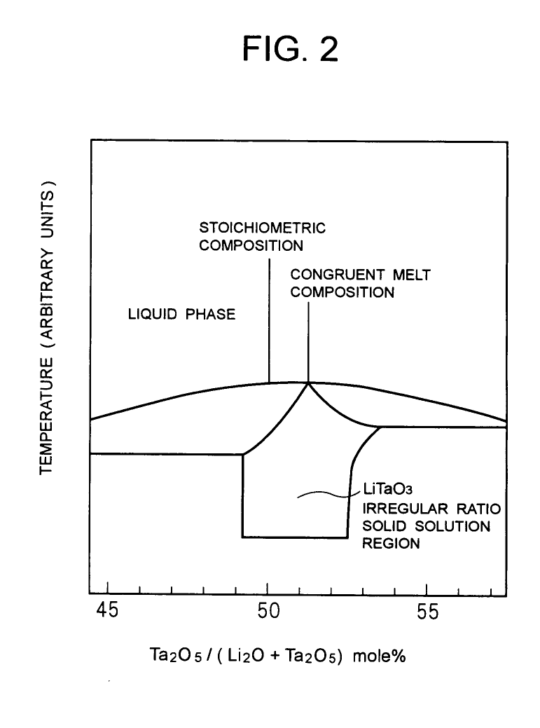

FIG. 2 is a general phase diagram of an Li₂O—Ta₂O₅ pseudo-bicomponent system.

As can be seen in the drawing, the congruent composition and the stoichiometric composition in LT differ from each other. The non-stoichiometric ratio solid solution region of LT at high temperatures extends toward an excess region of the Ta component, and the congruent composition has an excess restio of the Ta component.

In the present invention, an LT single crystal is produced at the composition in a range from the composition in which there is an excess of lithium (Li) than the congruent composition, and the composition in which there is a deficit of Li than the stoichiometric composition (in the present specification, such a compositional range is referred to as “near-stoichiometric composition” and an LT single crystal with such composition range is referred to as “NSLT single crystal”). An LT single crystal is provided in which the refractive index change occurs during irradiation with two beams of light having different wavelengths. Specifically, an LT single crystal whose composition is suitable for two-color holographic applications is provided.

A method for manufacturing an NSLT single crystal will next be described. An NSLT single crystal may, for example, be manufactured using the Czochralski technique. Each of the steps involved will now be described.

Step S100: Li₂CO₃ powder and Ta₂O₅ powder are weighed out and mixed. The starting material powder may be a commercially available high-purity (for example, 99.99%) powder. The Li₂CO₃ powder and Ta₂O₅ powder are prepared such that there is an excess of the Li component. For example, the Li₂CO₃:Ta₂O₅ molar ratio may be 0.57:0.43.

Step S110: The mixed powder of step S100 is sintered for 24 hours at 1000° C. The sintered material is subjected to a pressure of 1 t/cm² and molded, yielding a starting material for melting. The starting material for melting obtained in this manner is placed in an iridium crucible.

Step S120: The iridium crucible is heated to 1580° C. The starting material for melting is thereby melted, yielding an LT crystal starting material melt.

Step S130: An LT seed crystal is immersed and allowed to grow in the melt obtained in step S120. The growth conditions may, for example, correspond to a growth rate of 0.5 mm/h and a crystal rotational speed of 5 rpm. The growth atmosphere may, for example, be a mixed gas with a nitrogen/oxygen ratio of 99.95/0.05.

An NSLT single crystal is obtained in steps S100 to S130. The post-processing of the NSLT single crystal will be described next.

Step S140: The resulting NSLT single crystal is annealed for 24 hours at 1350° C. in the air. The strain of the NSLT single crystal is thereby relieved.

Step S150: A treatment to form a single domain is performed. To form a single domain, it is possible, for example, to use a field cooling process in which cooling is performed while a current of about 0.5 mA/cm² is passed in the direction parallel to the longitudinal axis of the columnar NSLT single crystal at about 730° C.

The NSLT single crystal that has been made into a single domain in this manner has a Curie temperature of 669° C. and the composition Li₂O/(Li₂O+Ta₂O₅)=0.4975.

In a growth method based on the aforementioned Czochralski technique, the differences in composition between the melt composition and the crystal composition increase during crystallization because there are differences between the composition of the melt and the composition of the crystal growing from the melt in step S130. As a result, a large NSLT single crystal with a uniform composition cannot be obtained. On the other hand, it is possible to use a single crystal growth equipment based on a double crucible technique in which a starting material with the same composition and in the same amount as the crystallized product is continuously fed. Such single crystal growth equipment consists of a double crucible structure. The bottom of an internal crucible is provided with an opening that connects with an external crucible. Following is a description of each of the steps involved in the method for manufacturing an NSLT single crystal by using a double crucible process with the continuous feeding of the starting material.

Step S200: A starting material containing an excess of the Li component is placed in the internal crucible and external crucible. Such a starting material can be produced in accordance with the same procedure as the one described in steps S100 to S110 above.

Step S210: The double crucible is heated to produce a melt for the NSLT single crystal.

Step S220: An LT seed crystal is immersed and grown in the melt obtained in step S210. The LT seed crystal is pulled up while being rotated under specific growth conditions. The weight of the crystal grown from the melt of the internal crucible is continuously measured during growth. A starting material adjusted to a near-stoichiometric composition is automatically fed to the external crucible in the same amount as the weight of the grown crystal. The melt composition can be kept constant because the starting material of the external crucible is allowed to flow from the external crucible to the internal crucible through the opening in the internal crucible. As a result, a large NSLT single crystal of uniform composition can be obtained.

The composition of the grown NSLT single crystal can be controlled by changing the growth temperature and the molar ratio of the starting material for the melt, as is evident from the phase diagram (FIG. 2).

The post-processing of the resulting NSLT single crystal is the same as in steps S140 to S150 above, and therefore the description there of is omitted. It should be understood, however, that the above-described method for manufacturing an NSLT single crystal is merely an example.

NSLT single crystals that had a variety of near-stoichiometric compositions and were obtained by the above-described method were cut into rectangular parallelepipeds (so-called Y-cut plates) whose principle plane is normal to a y-cut plane. The optical characteristics of crystal samples (crystals to be measured) that had a variety of compositions and obtained in such a manner were evaluated, and as a result the favorable compositions of the NSLT single crystals for two-color holographic applications were obtained. The thickness of an Y-cut plate (along the Y-axis) was 2 mm.

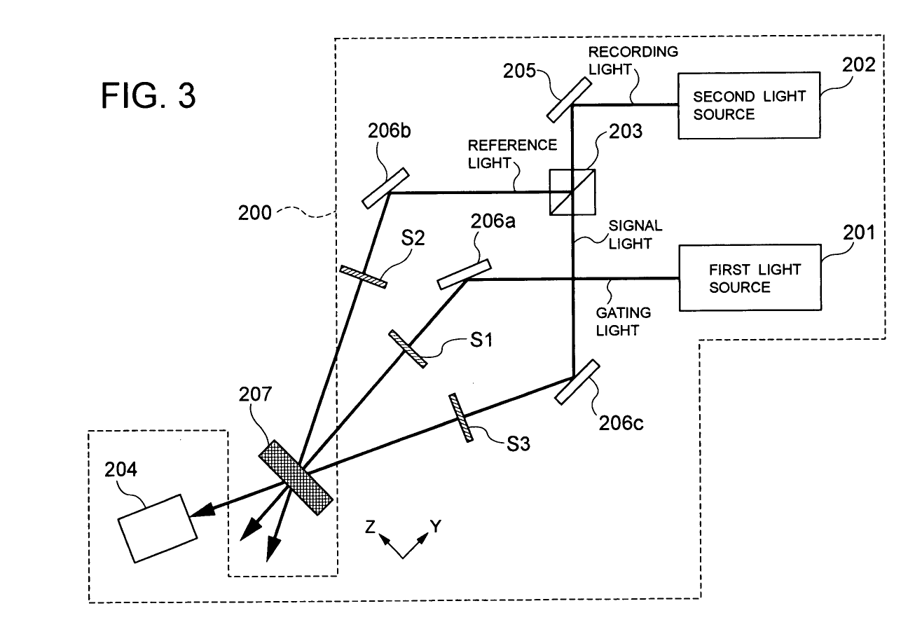

FIG. 3 is a schematic diagram of system 200 for measuring optical characteristics.

The measuring system 200 comprises a first light source 201 for emitting gating light, a second light source 202 for emitting recording light, a beam splitter 203 for dividing the recording light into reference light and signal light, a photodetector 204 for receiving the signal light, and shutters S1, S2, and S3 for blocking off the gating light, reference light, and signal light that are incident on the measured crystal 207, respectively. The measuring system 200 also comprises a mirror 205 for directing recording light to the beam splitter 203. The mirror 205 can be omitted if the recording light is directly incident on the beam splitter 203. The measuring system 200 further comprises mirrors 206a, 206b, and 206c for directing the gating light, reference light, and signal light to the measured crystal 207, respectively. With the mirrors 206a, 206b, and 206c, the incidence angles of gating light, reference light, and signal light can be adjusted such that the gating light, reference light, and signal light intersect at an arbitrary point on the measured crystal 207. Any optical system may be used as long as the mirrors 206a, 206b, and 206c can direct gating light, reference light, and signal light to the measured crystal 207 and cause these three beams to intersect at an arbitrary point.

The measured crystal 207 is disposed such that the gating light, reference light, and signal light are incident on the Y-cut plane. The reference light and signal light are polarized (form extraordinary rays) such that the electric-field vector of light is parallel to the Z-axis of the measured crystal 207.

A description will now be given of the method for measuring sensitivity and variations in the refractive index by using the measuring system 200. Gating light (350 nm, 0.16 W/cm²) and recording light (778 nm; signal light: 4.7 W/cm²; reference light: 4.1 W/cm²) are simultaneously emitted by the first light source 201 and second light source 202. The shutters S1 to S3 remain open in the process. The shutter S3 for blocking off the signal light closes for prescribed intervals at a certain stage. During this period, the photodetector 204 receives diffracted light of reference light diffracted from the hologram formed on the measured crystal 207. The intensity ratio η (diffraction efficiency) of reference light and diffracted light is thereby measured. The refractive index change An is calculated using Eq. (1).

η=T_{crystal} sin²(πΔnd/λ cos θ) (1)

In the equation, T_{crystal} is the transmittance of the measured crystal 207, λ is the thickness of the measured crystal 207, λ is the wavelength of light in a vacuum, and θ is ½ of the angle in the air (not in the crystal) at which the reference light and signal light intersect each other. The measurements continue until the intensity ratio η reaches saturation.

Sensitivity S is then calculated using Eq. (2).

$${S = \frac{\partial \sqrt{η}}{\partial r} \vert}_{t = 0} / ( {I}_{w} d ) \qquad ( 2 )$$

In the equation, I_{W} is the intensity of recording light.

The measurement results obtained using the measuring system 200 of FIG. 3 will now be described.

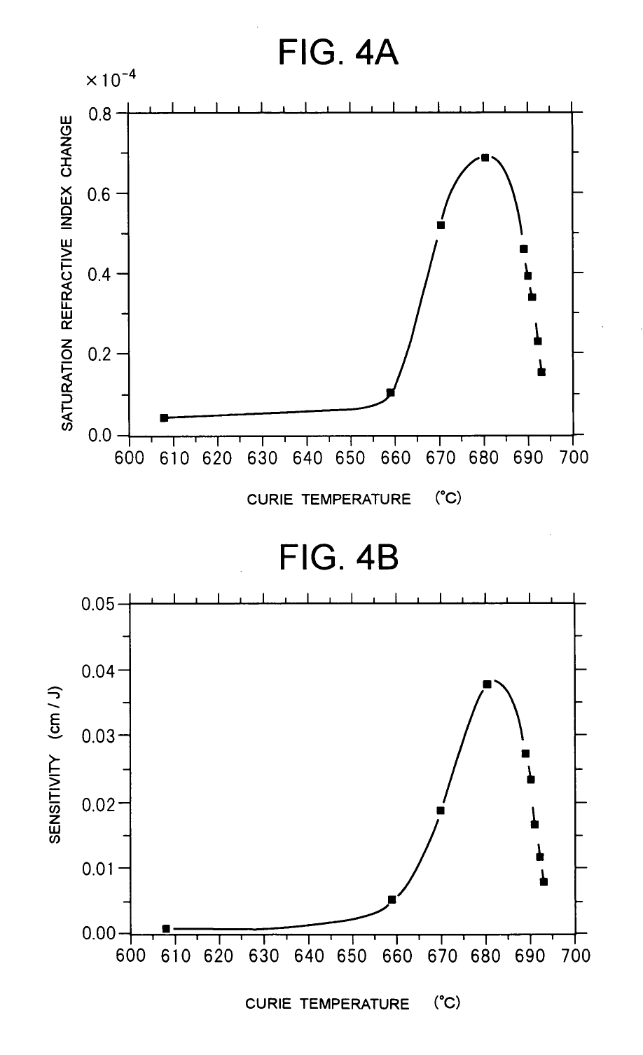

FIGS. 4A and 4B are diagrams depicting variations in the refractive index, and the dependence of sensitivity on the Curie temperature of a ferroelectric material comprising an NSLT single crystal in accordance with the present invention, respectively.

FIG. 4A shows results obtained by calculating the saturation refractive index change Δn from Eq. (1) by using the saturation value of the intensity ratio η for NSLT single crystals with different Curie temperatures Tc (compositions). The value of the saturation refractive index change Δn required for use in two-color holograms is known to be greater than 0.4×10⁻⁴. It can be seen from FIG. 4A that variations in the refractive index of an LT single crystal (Tc=693° C.; referred to hereinbelow as “an SLT single crystal”) having a stoichiometric composition and those of an LT single crystal (Tc=608° C.; referred to hereinbelow as “a CLT single crystal”) having a congruent melt composition are too narrow to be used in two-color holograms. It can also be seen from the curve in FIG. 4A that the range of Curie temperatures that satisfy the relation Δn>0.4×10⁻⁴ is from 665° C. to 690° C.

FIG. 4B shows results obtained by calculating sensitivity S from Eq. (2) by using the saturation value of the intensity ratio η for NSLT single crystals with different Curie temperatures Tc (compositions). The value of the sensitivity S required for use in two-color holograms is known to be greater than 0.02 cm/J. It can be seen from FIG. 4B that the sensitivity (0.01 cm/J) of an SLT single crystal and the sensitivity (0.003 cm/J) of a CLT single crystal are too low to be used in two-color holograms. It can also be seen from the curve in FIG. 4B that the range of Curie temperatures that satisfy the relation S>0.02 cm/J is from 670° C. to 690.5° C.

It can thus be seen from FIGS. 4A and 4B that the range of Curie temperatures that satisfy the relations Δn>0.4×10⁻⁴ and S>0.02 cm/J is from 670° C. to 690° C.

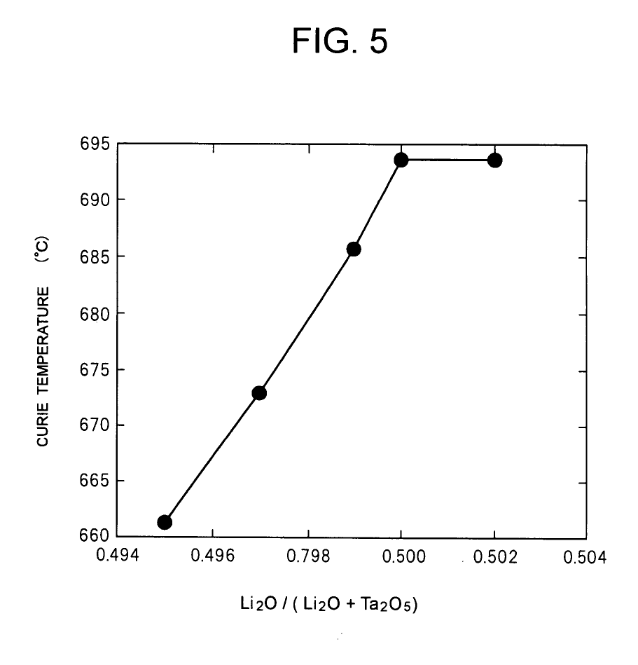

FIG. 5 is a diagram depicting the relation between the Curie temperature and composition of an LT single crystal.

In the present specification, the composition of an NSLT single crystal was determined using the graph shown in FIG. 5. A composition that corresponds to the Curie temperatures obtained from FIGS. 4A and 4B is 0.4966≦Li₂O/(Li₂O+Ta₂O₅)≦0.4995. An NSLT single crystal that satisfies this composition can be used for a two-color hologram. More preferably, the Curie temperature Tc is 680±5° C. (0.4974≦Li₂O/(Li₂O+Ta₂O₅)≦0.4989). An NSLT single crystal (thickness: 2 mm) with a Curie temperature Tc of 680° C. has a saturation refractive index change of 0.7×10⁻⁴ and can yield a diffraction efficiency of about 15.3%. This value is seven times greater than the saturation refractive index change (0.1×10⁻⁴) of a CLT single crystal containing doped Fe.

A ferroelectric material obtained from an NSLT single crystal that has the aforementioned compositional range in accordance with the present invention does not contain Fe or other impurities, and hence does not form any unneeded absorption bands in the wavelength region of gating light. It was therefore confirmed that even an NSLT single crystal as thick as 2 mm or greater can yield a sensitivity (not shown) as high as 0.02 cm/J or greater, as shown in FIG. 4B.

Returning to FIG. 3, a description will now be given of the method for measuring variations in the refractive index of a ferroelectric material that comprises an NSLT single crystal during the recording, playback, and erase steps. During the recording step (referred to hereinbelow as “period (a)”), gating light (313 nm, 0.2 W/cm²) and recording light (722 nm, 10 W/cm²) are simultaneously emitted by the first light source 201 and second light source 202. The shutters S1 to S3 remain open in the process. The shutter S3 for blocking off the signal light closes for prescribed intervals at a certain stage. During this period, the photodetector 204 receives diffracted light of reference light diffracted from the hologram formed on the measured crystal 207. The intensity ratio η (diffraction efficiency) of reference light and diffracted light is thereby measured. A hologram is thus formed (data is recorded) on the ferroelectric material that comprises an NSLT single crystal in period (a).

In the playback step (referred to hereinbelow as “period (b)”), shutters S1 and S3 close, and the measured crystal 207 is irradiated with reference light alone. That is, the measured crystal 207 is irradiated with recording light whose intensity is about half that during recording. In the process, the photodetector 204 receives diffracted light of reference light, and the intensity ratio η of reference light and diffracted light is measured. Recorded data is thus played back in period (b).

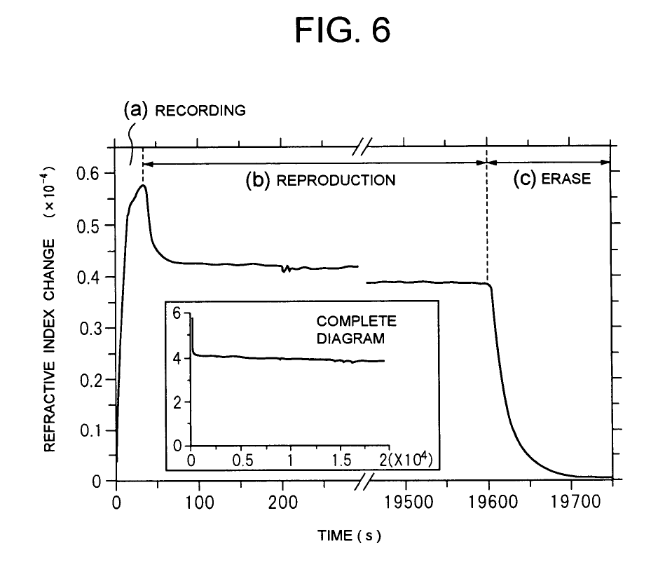

In the erasure step (referred to hereinbelow as “period (c)”), shutter S1 again opens, and the measured crystal 207 is irradiated with reference light and gating light. During this period, the photodetector 204 receives diffracted light of the reference light. The intensity ratio η of reference light and diffracted light is thereby measured. Recorded data is thus erased in period (c). The refractive index change Δn is determined by using Eq. (1) above on the basis of the resulting intensity ratio η in each of periods (a) to (c), the relation between Δn and measurement time t is plotted, and a graph depicting variations in the refractive index is obtained, as shown in FIG. 6. FIG. 6 depicts results for an NSLT single crystal whose Curie temperature Tc is 680±5° C., which is the most preferred temperature in FIGS. 4A and 4B.

A refractive index change of about 0.6×10⁻⁴ in period (a) was obtained in a short time from FIG. 6. This indicates that recording can be completed in a short time. The reason that the value of the saturation refractive index change differs from that of the NSLT single crystal with Tc=680° C. shown in FIG. 4A is that the light incident on the measured crystal 207 has a different intensity.

No significant signal degradation is seen in period (b) even when the data is played back with reference light that corresponds to an intensity that is about half the intensity of recording light during recording. It can therefore be seen that recorded data has good storage characteristics (playback nonvolatility) in a ferroelectric material that comprises an NSLT single crystal in accordance with the present invention (0.4966≦Li₂O/(Li₂O+Ta₂O₅)≦0.4995).

Furthermore, the playback nonvolatility of the ferroelectric material relating to the present invention was quantitatively evaluated using the gating ratio. As used herein, the term “gating ratio” refers to the ratio of the sensitivity during recording (period (a) in FIG. 6) under irradiation with gating light and the sensitivity during recording when there is no irradiation with gating light. The recording sensitivity of an NSLT single crystal with a Curie temperature Tc of 680±5° C. in the absence of irradiation with gating light is very low, and the gating ratio is about 5000. This value expresses the fact that the ferroelectric material relating to the present invention has very high playback nonvolatility.

In FIG. 6, playback nonvolatility is evaluated solely for an NSLT single crystal that has the most preferred composition, but it should be understood that substantially the same results as in FIG. 6 can be obtained for any NSLT single crystal that satisfies the condition 0.4966≦Li₂O/(Li₂O+Ta₂O₅)≦0.4995.

Based on the description of FIGS. 4A, 4B, and 6 given above, the inventors discovered that an NSLT single crystal has higher recording sensitivity and a more widely refractive index change than that of an SLT single crystal or a CLT single crystal during recording with a two-color holographic system, and identified the compositional range that is preferred for such recording. The reasons for this discovery will now be described.

It is believed that a higher recording sensitivity and a more widely varying refractive index are the results of intrinsic defects formed in the NSLT single crystal. Since an NSLT single crystal within the aforementioned compositional range has an Li deficiency (i.e., it is not a strictly stoichiometric composition), antisite defects (Ta_{Li}⁵⁺: a state in which Ta atoms are substituted in the deficient Li lattice sites), defect complexes (Ta^{Li}⁵⁺Ta_{Ta}⁵⁺: complex of Ta_{Li}⁵⁺ and Ta atoms in the Ta lattice sites adjacent thereto), and other intrinsic point defects form in the NSLT single crystal.

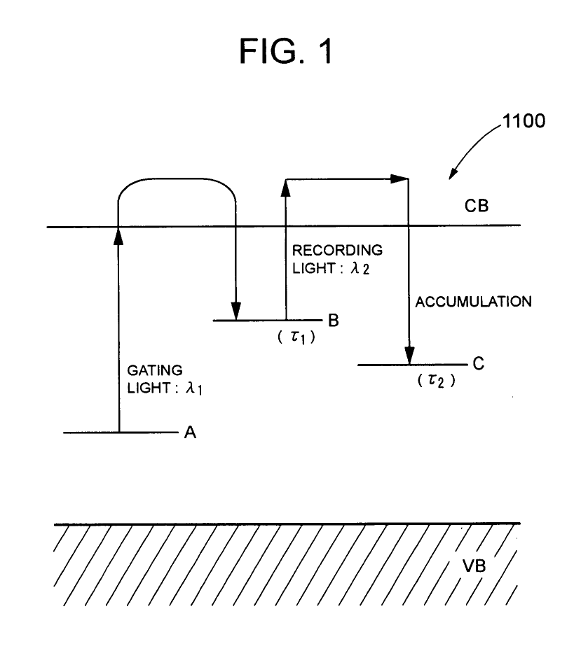

A bipolaron (Ta_{Li}⁴⁺Ta_{Ta}⁴⁺) is formed through the capture of two electrons with mutually opposite spins by such composite defects (Ta_{Li}⁵⁺Ta_{Ta}⁵⁺). Irradiating the NSLT single crystal with light (gating light) that has an energy necessary for dissociating the bipolaron to form electrons excited into the conduction band (CB in FIG. 1). The excited electrons are captured by the antisite defects and to form a small polaron (Ta_{Li}⁴⁺).

Therefore, referring to FIG. 1, it is assumed that a bipolaron forms a deep trap level (energy level A) that serves as a gate source, and that a small polaron (SP) forms an intermediate excitation level (energy level B) in an NSLT single crystal with the above-described compositional range relating to the present invention. Based on this assumption, the concentration of gate sources should increase with an increase in antisite defects. This means that the concentration of gate sources is lower for NSLT single crystals that are closer to the stoichiometric composition, and higher for NSLT single crystals that are closer to the congruent composition.

On the other hand, the trap lifetime (lifetime at the intermediate excitation level) decreases with an increase in defects density. This means that the trap lifetime is longer for NSLT single crystals that are closer to the stoichiometric composition, and shorter for NSLT single crystals that are closer to the congruent composition. This is because an increase in the defects causes deep recombination centers to form, and hence increases the recombination rate of electrons at the SP level.

The aforementioned considerations related to the concentration of gate source and the trap lifetime suggest that an NSLT single crystal has a preferred compositional range when the refractive index change of the NSLT single crystal are utilized (particularly when the USLT single crystal is used for two-color hologram). It can be seen from the experimental results shown in FIGS. 4A, 4B, and 6 that the preferred compositional range is 0.4966≦Li₂O/(Li₂O+Ta₂O₅)≦0.4995 (670° C.≦Tc≦690° C.), and that the most preferred compositional range is 0.4974≦Li₂O/(Li₂O+Ta₂O₅)≦0.4989 (Tc=680±5° C.).

A description for measuring the decay time constant and the (data) storage lifetime will now be given with reference to FIG. 3. An “accelerated lifetime test” will be used herein. Using this “accelerated lifetime test” makes it possible to reduce the measurement time. The measuring system 200 in FIG. 3 is provided with a heater (not shown) for heating the measured crystal 207, and a filter (not shown) for controlling the intensity of light in the optical path of reference light. With the aid of the heater, the measured crystal 207 with recorded data is heated and kept at a prescribed temperature above room temperature. The shutters S1 and S3 are then closed, and only the reference light from the second light source 202 is allowed to reach the measured crystal 207. The intensity of reference light is reduced with the filter. The intensity ratio η (diffraction efficiency) of reference light and diffracted light is measured during a prescribed period (for example, 30 s). The decay time constant (lifetime) at a specific temperature is obtained based on the measurement results. The measured crystal 207 is subsequently cooled, data is recorded, and the same measurement is repeated at a different temperature.

Eq. (3) is applied to the decay time constant obtained in this manner at each temperature.

t_{d}(T)=t_{d0}exp(Eₐ/k_{B}T) (3)

In the equation, Eₐ is the activation energy, k_{B} is the Boltzmann constant, and T is the absolute temperature.

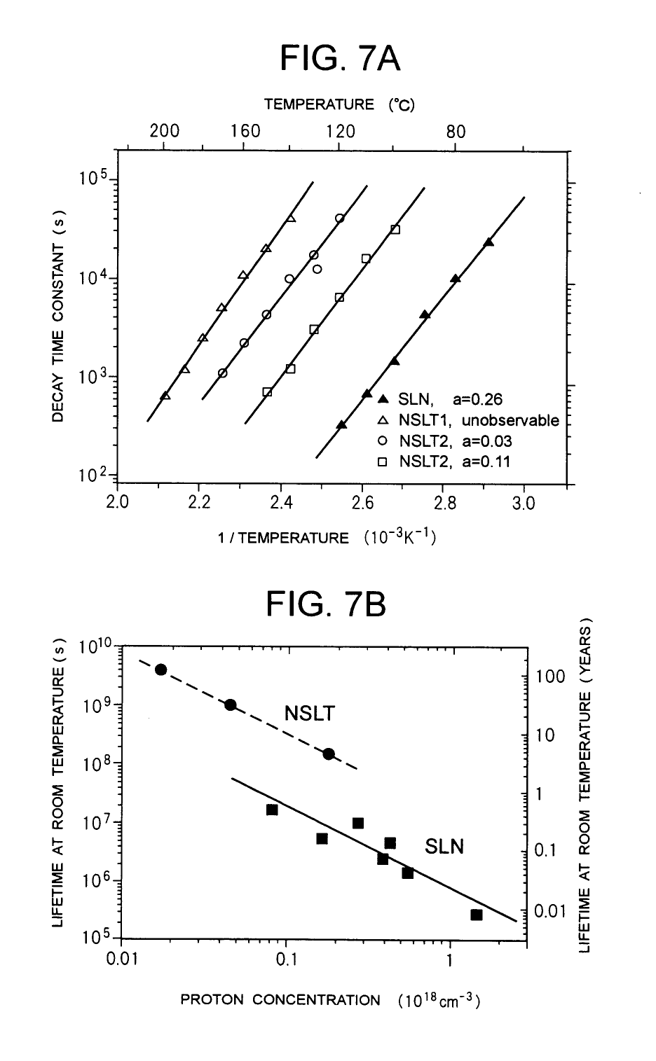

FIGS. 7A and 7B are diagrams depicting the temperature dependence of the decay time constant and the proton concentration dependence of storage lifetime at room temperature, respectively.

FIG. 7A shows results of the temperature dependence (Arrhenius plot) for the decay time constant of NSLT single crystals that have the composition 0.4966≦Li₂O/(Li₂O+Ta₂O₅)≦0.4995 (670° C.≦Tc≦690° C.) and various proton concentrations, and LN single crystals that have the stoichiometric composition and a specific proton concentration, as well as the results of fitting performed using Eq. (3).

The concentration of protons in a single crystal was identified based on the infrared absorption coefficient (α_{[OH]}) of the [OH] stretching mode by using an infrared absorption spectrometer. FIG. 7A shows solely the measurement results for an NSLT single crystal (NSLT1; shown with triangles) for which infrared absorption based on the [OH] stretching mode has not been measured (0 cm⁻¹; in the present specification, the detection limit of infrared absorption based on the [OH] stretching mode is treated as a substantial absence of protons in the NSLT single crystal), an NSLT single crystal (NSLT2; circles) whose infrared absorption α was 0.03 cm⁻¹, an NSLT single crystal (NSLT3; squares) whose infrared absorption α was 0.11 cm⁻¹, and an LN single crystal (SLN; solid triangles) with an infrared absorption α of 0.26 cm⁻¹, shown for reference purposes.

It can be seen from FIG. 7A that data storage lifetime increases with a reduction in the concentration of protons in the single crystal when NSLT single crystals of the same composition are used. In particular, the data storage lifetime of NSLT1 is about 30 times that of NSLT3.

FIG. 7B shows the proton concentration dependence of the data storage lifetime for NSLT and SLN single crystals at room temperature, determined based on the results in FIG. 7A. It is known that in the case of LN, the concentration of protons contained in the crystal has an effect on storage lifetime. It was learned that the data storage lifetime of an NSLT single crystal with the above compositional range relating to the present invention was about 15 times greater than the lifetime of an SLN single crystal. For example, the data storage lifetime of an NSLT single crystal with α=0.01 cm⁻¹ (proton concentration: 0.02×10¹⁸ cm⁻³) at room temperature is about 160 years, and such a data storage lifetime is much longer than the storage lifetime (90 days) of an Fe-doped CLT single crystal at room temperature. It can be seen from the above that a ferroelectric material that comprises an NSLT single crystal with the above composition relating to the present invention has a greater data storage lifetime than that of a conventional material, and can be used as a recording medium for recording localized variations in the refractive index, particularly, as a recording medium for two-color holograms. In particular, an even more preferred data storage lifetime can be ensured with a ferroelectric material that comprises an NSLT single crystal whose proton concentration is such that the infrared absorption coefficient in the [OH] stretching mode falls within a range of 0 cm⁻¹ to 0.15 cm⁻¹ (where 0 cm⁻¹ and 0.15 cm⁻¹ are included in the range).

As described above, the present invention provides a ferroelectric material that comprises an NSLT single crystal suitable for two-color holograms. A ferroelectric material that comprises an NSLT single crystal with the compositional range 0.4966≦Li₂O/(Li₂O+Ta₂O₅)≦0.4995 (670° C.≦Tc≦690° C.) has an appropriate concentration of gate sources and an adequate trap lifetime even when the NSLT single crystal is not subjected to a post-growth reduction treatment, and hence exhibits the recording sensitivity and refractive index change that are necessary for two-color holograms. The resulting recording sensitivity is higher than in the past and allows a photorefractive effect to be produced using gating light whose intensity is lower than in the past. The ferroelectric material that comprises an NSLT single crystal in accordance with the present invention does not contain any dopants, and hence does not form any unneeded absorption bands in the wavelength region of gating light. For this reason, large recording capacity can be attained because ferroelectric materials that are thicker than in the past can be used.

Embodiment 1 was described particularly with reference to applications involving two-color holograms, but the ferroelectric material relating to the present invention is not limited to the two-color holograms. It should be understood that the ferroelectric material relating to the present invention can be used in any application that utilizes variations in the refractive index that result from irradiation with two light beams (gating light and recording light) having different wavelengths.

(Embodiment 2)

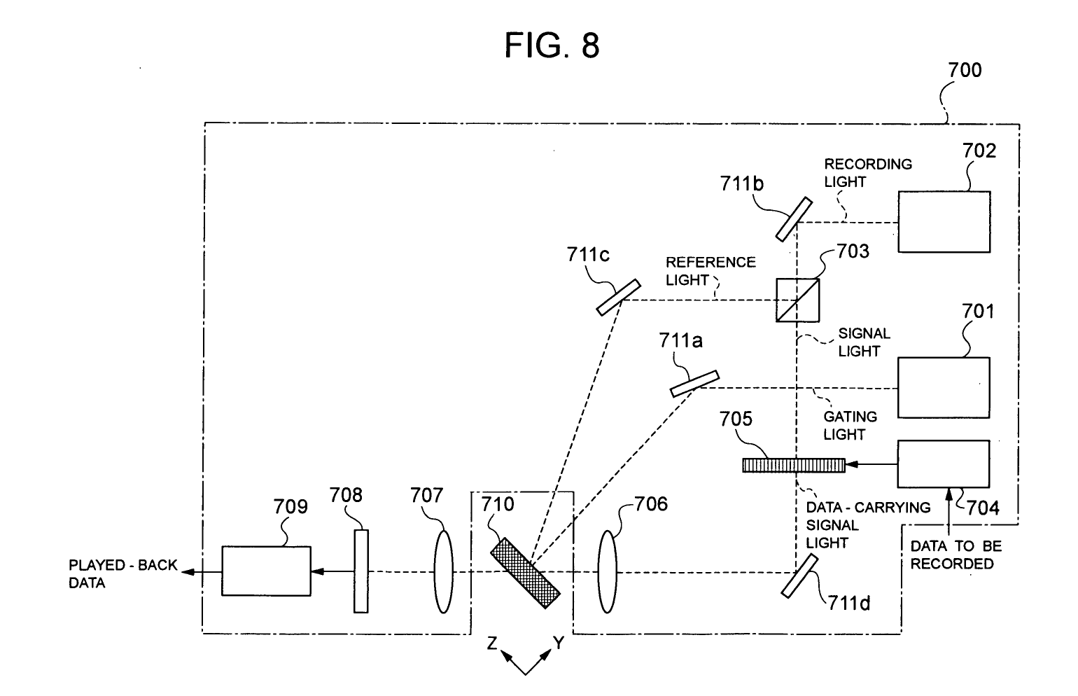

FIG. 8 is a schematic diagram of a recording/playback apparatus 700 for recording information on a two-color holographic recording medium according to the present invention, and/or playing back information from the two-color holographic recording medium.

The ferroelectric material that comprised an NSLT single crystal with the compositional range 0.4966≦Li₂O/(Li₂O+Ta₂O₅)≦0.4995 (670° C.≦Tc≦690° C.) and was described in connection with embodiment 1 was cut and polished to a specific shape and size, and a two-color holographic recording medium was fabricated. For example, the two-color holographic recording medium can have a size and shape that corresponds to a 1-cm cube, but is not limited to this size and shape alone.

The recording/playback device 700 comprises a first light source 701 for emitting gating light, a second light source 702 for emitting recording light, a beam splitter 703 for dividing the recording light into reference light and signal light, an encoder 704 for converting the digital data to be recorded into page-wise sequential data, a spatial light modulator 705 for optically modulating signal light in accordance with the page-wise sequential data, a 4f-based Fourier transform lens 706 for performing a Fourier transform on the optically modulated signal light, a reverse Fourier transform lens 707 for performing a reverse Fourier transform on playback light that has been caused to undergo interference by the two-color holographic recording medium 710 relating to the present invention, a photodetector 708 for receiving the playback light that has undergone the reverse Fourier transform, and a decoder 709 for converting the received playback light to digital data.

The first light source 701 may, for example, be an YAG laser third-harmonic generator (THG), or a GaN or other semiconductor laser, but is not limited to these options alone. The wavelength of gating light generated by the first light source 701 may, for example, be 350 nm. The second light source 702 may, for example, be an AlGaAs-based semiconductor laser with a single longitudinal mode, but is not limited to this option alone. The second light source 702 emits recording light whose wavelength is greater than that of gating light. The recording light emitted by the second light source 702 may, for example, have a wavelength of 850 nm and is coherent light.

The encoder 704 converts digital data to a dot pattern image that expresses light and shade in a plane. The encoder 704 rearranges the converted dot pattern image into, for example, a data array that measures 480 bits along and 640 bits across, and generates page-wise sequential data.

The spatial light modulator 705 may, for example, be a panel for a transmission-type TFT liquid crystal display (LCD), but is not limited to this option alone. The spatial light modulator 705 receives the page-wise sequential data and signal light. The spatial light modulator 705 has modulation processing units that are 480 pixels along and 640 pixels across and correspond to individual pages, and optically modulates signal light into the on-off signals of spatial light in accordance with the page-wise sequential data.

The photodetector 708 may, for example, be a charge-coupled device (CCD). The photodetector 708 converts playback light into the strength of an electric signal and generates an analog electric signal whose level corresponds to the brightness of playback light.

The decoder 709 compares the analog electric signal with a specific amplitude value (slice level), and generates digital data.

The recording/playback device 700 further comprises a mirror 711a for directing gating light to the two-color holographic recording medium 710, a mirror 711b for directing recording light to the beam splitter 703, and mirrors 711c and 711d for directing reference light and signal light, respectively, to the two-color holographic recording medium 710. Mirrors 711a to 711d may be omitted in some optical system designs.

Following is a description of an operation in which information is recorded on the two-color holographic recording medium 710 relating to the present invention by using the recording/playback device 700.

The first light source 701 emits gating light. The second light source 702 emits recording light at the same time. The two-color holographic recording medium 710 is irradiated with gating light via the mirror 711a. Carriers that contribute to the photorefractive effect are thereby produced in the two-color holographic recording medium 710. The recording light is divided by means of the beam splitter 703 into reference light and signal light. (It should be noted, however, that at this point the signal light does not have any information for recording.) The two-color holographic recording medium 710 is irradiated with reference light at a specific angle via the mirror 711c.

The signal light has information to be recorded on the two-color holographic recording medium 710 after passing through the spatial light modulator 705. The two-color holographic recording medium 710 is irradiated with signal light via the mirror 711d and the 4f-based Fourier transform lens 706.

The reference light and Fourier-transformed signal light undergo interference in the two-color holographic recording medium 710. Interference fringes form in the area in which the reference light and signal light intersect each other in the two-color holographic recording medium 710, and the refractive index change occurs according to the contrast of the interference fringes. These interference fringes are recorded as a refractive index lattice. Information is thus recorded on the two-color holographic recording medium 710. A plurality of pieces of page-wise sequential data can be recorded in an angle-multiplexed manner by varying the angle of incidence of reference light, and a three-dimensional data recording can be obtained.

Following is a description of the operation in which information recorded on the two-color holographic recording medium 710 relating to the present invention is played back using the recording/playback device 700.

The second light source 702 emits recording light. A shutter (not shown) is disposed between the beam splitter 703 and spatial light modulator 705 not to direct signal light on the two-color holographic recording medium 710. It is also possible to adopt an arrangement in which the first light source 701 does not emit gating light or in which a shutter or the like is disposed between the first light source 701 and two-color holographic recording medium 710 to prevent gating light from being incident on the two-color holographic recording medium 710.

Playback light that results from playing back the Fourier-transformed signal light from the recorded refractive index lattice is generated on the opposite side from the two-color holographic recording medium 710 irradiated with reference light. The playback light is directed to the photodetector 708 via the reverse Fourier transform lens 707. Digital data is subsequently played back by means of the decoder 709. The information recorded on the two-color holographic recording medium 710 is thus played back.

According to the present invention, the two-color holographic recording medium 710 is fabricated from a ferroelectric material that comprises an NSLT single crystal. The NSLT single crystal has the compositional range 0.4966≦Li₂O/(Li₂O+Ta₂O₅)≦0.4995 (670° C.≦Tc≦690° C.). The ferroelectric material has an appropriate concentration of gate sources and an adequate trap lifetime even without undergoing a post-growth reduction treatment, and can therefore exhibit the recording sensitivity and refractive index change that are necessary for two-color holograms. The two-color holographic recording medium 710 in accordance with the present invention does not contain any dopants, and hence does not form any unneeded absorption bands in the wavelength region of gating light. For this reason, large capacity can be provided because the two-color holographic recording medium is thicker than in the past.

(Embodiment 3)

The ferroelectric material that relates to the present invention and was described in connection with embodiment 1 may be used for a wavelength selection filter.

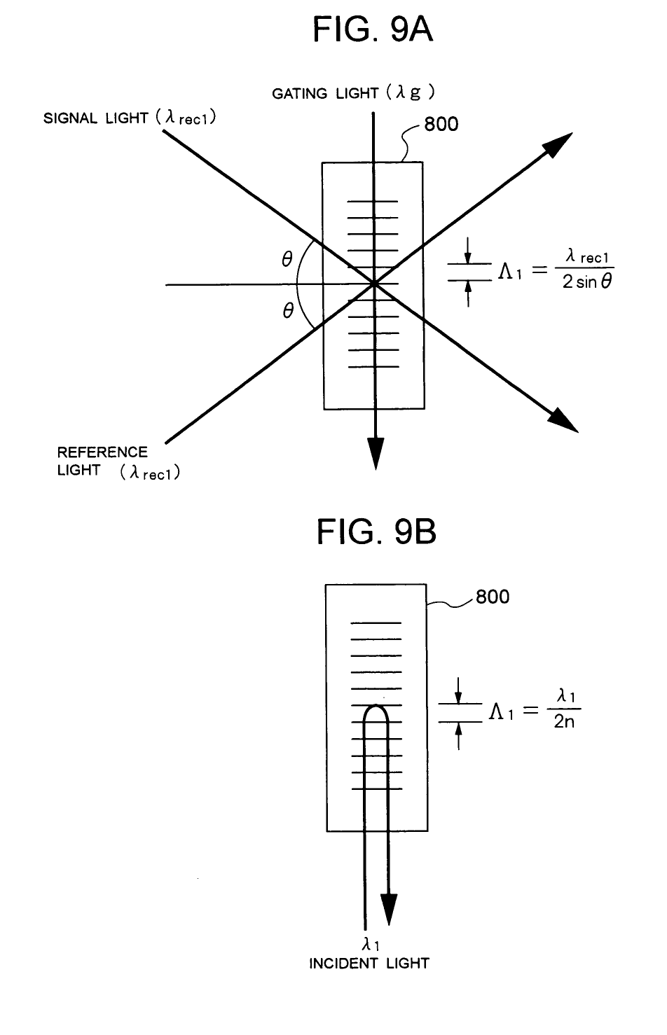

FIGS. 9A and 9B are schematic diagrams illustrating the method for fabricating a wavelength selection filter and principle of the wavelength selection filter. The steps involved in the fabrication of the wave selection filter will be described with reference to FIG. 9A. The measuring system 200 in FIG. 2 of embodiment 1, or the recording/playback device 700 of embodiment 2 is used to irradiate a ferroelectric material 800 relating to the present invention with gating light (wavelength: λ_{g}), coherent signal light (wavelength: λ_{rec1} (in air)), and reference light (wavelength: λ_{rec1} (in air)). Interference fringes form in the area in which the reference light and signal light intersect each other in the ferroelectric material 800. Variations in the refractive index due to the electrooptic effect occur along the contrast portions of the interference fringes, and a refractive index lattice is formed and recorded. The ferroelectric material 800 in which such a refractive index lattice has been recorded functions as a wavelength selection filter.

The principle of the wavelength selection filter will now be described. The relation between the Bragg angle θ (in air) and the inter-lattice pitch Λ₁ in a ferroelectric material 800 irradiated with signal light and reference light satisfies Eq. (4) below.

Λₜ=λ_{rec1}/(2 sin θ) (4)

A refractive index lattice with such an inter-lattice pitch is formed and, for example, incident light with wavelength λ₁ is introduced into the wavelength selection filter 800 that has refractive index n. If the inter-lattice pitch Λ₁ satisfies Eq. (5) below

Λₜ=λₜ/(2·n) (5),

then the incident light λ₁ is reflected by the wavelength selection filter 800, as shown in FIG. 9B.

For example, the wavelength selection filter 800 can reflect 1550-nm incident light when signal light and reference light have a wavelength of 647 nm (in air), and the Bragg angle is 56.6° (in air).

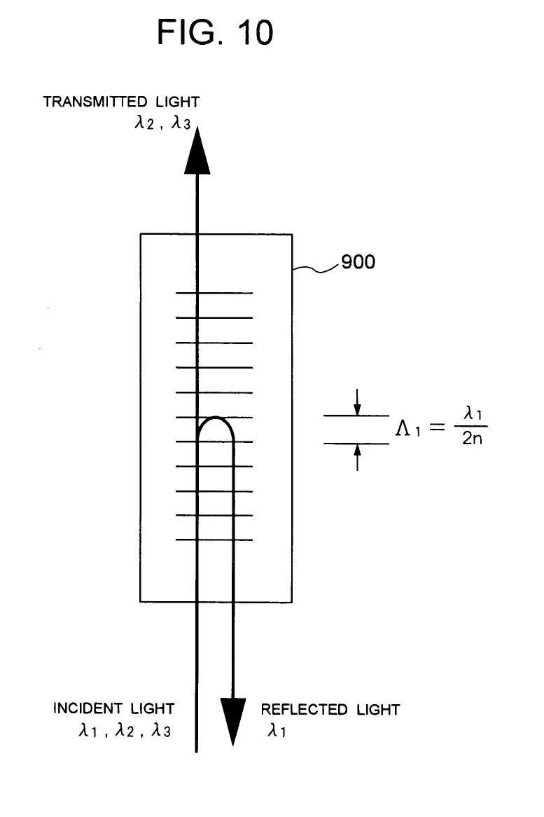

The wavelength selection filter 800 described with reference to FIGS. 9A and 9B may, for example be a wavelength selection filter for wave division multiplexing (referred to hereinbelow as “WDM”) communication systems. FIG. 10 is a schematic diagram of a WDM wavelength selection filter 900. The WDM wavelength selection filter 900 has a refractive index lattice with the inter-lattice pitch Λ₁=λ₁/(2·n). Directing incident light that contains wavelengths λ₁, λ₂, and λ₃ to the WDM wavelength selection filter 900 allows the WDM wavelength selection filter 900 to reflect only light with the wavelength λ₁ and to transmit light with the wavelengths λ₂ and λ₃. In conventional practice, light of wavelength λ₁ was separated by means of a beam splitter or other optical element.

The wavelength selection filter relating to the present invention can be fabricated from a ferroelectric material that comprises an NSLT single crystal with the compositional range 0.4966≦Li₂O/(Li₂O+Ta₂O₅)≦0.4995 (670° C.≦Tc≦690° C.), as described in connection with embodiment 1. The NSLT single crystal is free of impurities, and hence has high light transmissivity. The selectivity of the filter can therefore be improved by increasing the thickness of the NSLT single crystal. In addition, filter characteristics can be maintained for a long time because the NSLT single crystal has high nonvolatility and a long data storage lifetime.

A refractive index lattice recorded in the wavelength selection filter relating to the present invention can be easily rewritten. Wavelength selection filters having different inter-lattice pitches can be fabricated by a process in which the Bragg angle θ in Eq. (4) above is varied and refractive index lattices are recorded on the wavelength selection filter. The wavelength of reflected light (i.e., light reflected by the wavelength selection filter) can be easily selected thereby.

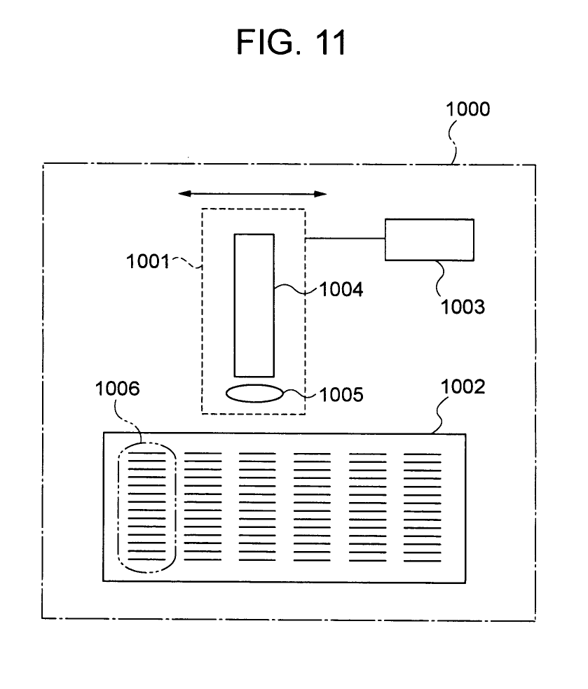

FIG. 11 is a schematic diagram depicting a filter system 1000 according to the present invention.

The filter system 1000 in accordance with the present invention comprises a light source unit 1001, a wavelength selection filter 1002, and a transport unit 1003 for moving the light source unit 1001.

The light source unit 1001 comprises an optical fiber 1004 for transmitting a plurality of types of light with different wavelengths and emitting the light through the end portion thereof, and a collimator lens 1005 for converting the light from the optical fiber 1004 into parallel light and directing the light to the wavelength selection filter 1002.

The wavelength selection filter 1002 can be fabricated from the ferroelectric material based on the present invention and described in connection with embodiment 1. The wavelength selection filter 1002 has a plurality of refractive index lattices 1006, and the inter-lattice pitches of the refractive index lattices 1006 may differ from each other. The area on the NSLT single crystal irradiated with gating light should be restricted using a mask or the like in order to fabricate a plurality of refractive index lattices 1006 on a single recording medium in this manner. In FIG. 11, the plurality of refractive index lattices 1006 is arranged in parallel, but this is not the only possible option.

The transport unit 1003 is connected to the light source unit 1001. The transport unit 1003 moves the light source unit 1001 to ensure that light from the light source unit 1001 is directed to the refractive index lattice that corresponds to the wavelength to be selected. The transport unit 1003 may be connected to the wavelength selection filter 1002. In this case the transport unit 1003 moves the wavelength selection filter 1002 to ensure that light from the light source unit 1001 is directed to the refractive index lattice that corresponds to the wavelength to be selected.

With such a filter system 1000, light that has specific wavelength components can be easily extracted from light that has a plurality of wavelength components.

The present invention provides a ferroelectric material in which variations in the refractive index can be induced by irradiation with two light beams having different wavelengths. Such a ferroelectric material is a lithium tantalate single crystal with the composition Li₂O/(Li₂O+Ta₂O₅)=0.4966 to 0.4995.

The ferroelectric material relating to the present invention has an appropriate concentration of gate sources and an adequate trap lifetime even without a post-growth reduction treatment, and can therefore exhibit the recording sensitivity and refractive index change that are necessary for two-color holograms. The resulting recording sensitivity is higher than in the past and allows the photorefractive effect to be produced using gating light whose intensity is lower than in the past.

In addition, the ferroelectric material relating to the present invention does not contain any dopants, and hence does not create any unneeded absorption bands in the wavelength region of gating light. Using the ferroelectric material relating to the present invention for a two-color holographic recording medium allows larger volumes to be recorded because thicker ferroelectric materials can be used than in the past.

The ferroelectric material relating to the present invention has high recording sensitivity and a longer data storage lifetime. Using the ferroelectric material relating to the present invention for a wavelength selection filter allows the characteristics of the filter to be maintained for a long time (that is, stable operation to be ensured). In addition, the ferroelectric material relating to the present invention does not contain any doped impurities, and hence allows thick wavelength selection filters to be fabricated. Filter selectivity is increased as a result.

This application is based on Japanese Patent Applications Nos. 2003-69897 and 2004-40215 which are herein incorporated by reference

What is claimed is:

1. A ferroelectric material in which variations in the refractive index are induced by irradiation with light at two different wavelengths, wherein the ferroelectric material is a lithium tantalate single crystal with the composition Li₂O/(Li₂O+Ta₂O₅)=0.4966 to 0.4995.

2. The ferroelectric material according to claim 1, wherein the ferroelectric material is a lithium tantalate single crystal with the composition Li₂O/(Li₂O+Ta₂O₅)=0.4974 to 0.4989.

3. The ferroelectric material according to claim 1, wherein the concentration of protons contained in the lithium tantalate single crystal is such that the infrared absorption coefficient in the [OH] stretching mode falls within a range of 0 cm⁻¹ to 0.15 cm⁻¹ (0 cm⁻¹ and 0.15 cm⁻¹ are included in the range).

4. A two-color holographic recording medium obtained using a ferroelectric material in which variations in the refractive index are induced by irradiation with light at two different wavelengths, wherein the ferroelectric material is a lithium tantalate single crystal with the composition Li₂O/(Li₂O+Ta₂O₅)=0.4966 to 0.4995.

5. The two-color holographic recording medium according to claim 4, wherein the ferroelectric material is a lithium tantalate single crystal with the composition Li₂O/(Li₂O+Ta₂O₅)=0.4974 to 0.4989.

6. The two-color holographic recording medium according to claim 4, wherein the concentration of protons contained in the lithium tantalate single crystal is such that the infrared absorption coefficient in the [OH] stretching mode falls within a range of 0 cm⁻¹ to 0.15 cm⁻¹ (0 cm⁻¹ and 0.15 cm⁻¹ are included in the range).

7. A wavelength selection filter obtained using a ferroelectric material in which variations in the refractive index are induced by irradiation with light at two different wavelengths, wherein the ferroelectric material is a lithium tantalate single crystal with the composition Li₂O/(Li₂O+Ta₂O₅)=0.4966 to 0.4995; and
the ferroelectric material has at least one refractive index grating.

8. The wavelength selection filter according to claim 7, wherein the ferroelectric material comprises two or more refractive index lattices; and
the two or more refractive index lattices have respectively different interstitial pitches.

9. The wavelength selection filter according to claim 7, wherein the ferroelectric material is a lithium tantalate single crystal with the composition Li₂O/(Li₂O+Ta₂O₅)=0.4974 to 0.4989.

10. The wavelength selection filter according to claim 7, wherein the concentration of protons contained in the lithium tantalate single crystal is such that the infrared absorption coefficient in the [OH] stretching mode falls within a range of 0 cm⁻¹ to 0.15 cm⁻¹ (O cm⁻¹ and 0.15 cm⁻¹ are included in the range).
